(19) United States
(12) Patent Application Publication
(10) Pub. No.: US 2009/0255423 A1
(43) Pub. Date: Oct. 15, 2009

(54) Printing Device For Printing Cylindrical or Spherical Objects

(76) Inventor: Jose Valls, Charlotte, NC (US)

Correspondence Address: JOHN B. STEVENS, JR., 15 NORTH KING STREET, SUITE 203, LEESBURG, VA, 20176, US

(21) Appl. No.: 12/391,765

(22) Filed: Feb. 24, 2009

Related U.S. Application Data
(60) Provisional application No. 61/043,625, filed on Apr. 9, 2008.

(51) Int. Cl. B41J 1/60

(52) U.S. Cl. 101/110

(57) ABSTRACT

The present invention provides for a printing device for printing the surface of a cylindrical or spherical object, including a drive mechanism, a printing mechanism, and a rolling mechanism, wherein the rolling mechanism includes a first shaft and a second shaft positioned in a spaced-apart relationship for receiving the object to be printed, wherein the drive mechanism rotates at least the first shaft, causing the object to rotate.

### CROSS REFERENCE TO RELATED PATENT APPLICATION

The current application claims the benefit of the earlier priority filing date of the provisional application, Ser. No. 61/043,625, that was filed on Apr. 9, 2008.

### FIELD OF THE INVENTION

The present invention relates generally to a printing device, and more particularly to a printing device for printing on a cylindrical or spherical surface.

### BACKGROUND OF THE INVENTION

The art of printing using a machine has been around for centuries with the invention of the printing press. These machines were purely mechanical machines that had very limited functionality. Over the years, printing systems developed from a purely mechanical machine to highly sophisticated computer controlled printing systems. Such printing systems are utilized everyday in office buildings around the word, whereby documents are printed on flat materials and objects, such as paper and the like. Most of the present systems employ an inkjet printing system for printing the images on the flat objects.

Inkjet printers operate to create an image on a surface by inserting droplets of liquid ink onto the surface. These printers are easy to use, produce a high quality image, and are relatively inexpensive. These printers are designed to accept flat paper for printing, but it is impossible to print an image onto an object with a width any thicker than a piece of paper. In addition, these printers do not have the capability to print an image on an object that is cylindrical or spherical in shape.

A need exists for a printing device that is capable of printing images on cylindrical or spherical objects, is easy to use, operate, and control, and produces a high quality image.

### BRIEF SUMMARY OF THE INVENTION

According to an embodiment of the present invention, the printing device for printing on a cylindrical or spherical surface includes a drive mechanism, a master gear that is rotated by the drive mechanism, a first shaft engaged to the master gear that is rotated by the master gear, a first barrel substantially enclosing the first shaft for receiving the cylindrical or spherical surface, a second shaft positioned parallel to the first shaft, and a second barrel substantially enclosing the second shaft positioned in close proximity to the first barrel.

According to another embodiment of the present invention, the printing device includes a stabilization device positioned on the first barrel and the second barrel for retaining the cylindrical or spherical surface.

According to yet another embodiment of the present invention, the printing device includes a pair of block members for receiving the first shaft and the second shaft.

According to yet another preferred embodiment of the present invention, the printing device of the present invention includes a transfer gear positioned on the distal end of the first shaft.

According to yet another preferred embodiment of the present invention, the printing device includes a gear positioned on the distal end of the second shaft which is connected to the transfer gear by way of a belt for rotating the second shaft.

According to yet another preferred embodiment of the present invention, the printing device includes a frame having four sides forming a void therein for positioning the printing device.

According to yet another preferred embodiment of the present invention, the printing device includes a printing mechanism for printing the cylindrical or spherical object.

According to yet another preferred embodiment of the present invention, the printing device includes a frame, a printing mechanism, a drive mechanism, a master gear that is rotated by the drive mechanism, a first shaft engaged to the master gear that is rotated by the master gear, a first barrel substantially enclosing the first shaft for receiving the cylindrical or spherical surface, a second shaft positioned parallel to the first shaft, and a second barrel substantially enclosing the second shaft positioned in close proximity to the first barrel.

According to yet another preferred embodiment of the present invention, the printing device includes a retention device for positioning and rotating the cylindrical or spherical surface to be printed.

According to yet another preferred embodiment of the present invention, the printing device includes a frame member for positioning the printing mechanism.

According to yet another preferred embodiment of the present invention, the printing device of the present invention includes an ink jet printing mechanism.

According to yet another preferred embodiment of the present invention, the printing device includes an indent positioned within the barrels for retaining the cylindrical or spherical object to be printed.

According to yet another preferred embodiment of the present invention, the printing device includes a ring positioned on the first barrel and a ring positioned on the second barrel that increases the diameter of the first barrel and the second barrel.

According to yet another preferred embodiment of the present invention, the printing device includes a frame, a printing mechanism, a drive mechanism, a master gear that is rotated by the drive mechanism, a first shaft engaged to the master gear that is rotated by the master gear, a first barrel substantially enclosing the first shaft for receiving the cylindrical or spherical surface, a second shaft positioned parallel to the first shaft, a second barrel substantially enclosing the second shaft positioned in close proximity to the first barrel, and a stabilization device positioned on the first barrel and the second barrel for retaining the cylindrical or spherical surface.

According to yet another preferred embodiment of the present invention, the printing device includes a pair of block members for receiving the first shaft and the second shaft.

According to yet another preferred embodiment of the present invention, the printing device includes four bearings positioned in the block members for receiving the first shaft and the second shaft.

According to yet another preferred embodiment of the present invention, the printing device includes a transfer gear positioned on the distal end of the first shaft.

According to yet another preferred embodiment of the present invention, the printing device includes a gear positioned on the distal end of the second shaft which is connected to the transfer gear by way of a belt for rotating the second shaft.

According to yet another preferred embodiment of the present invention, the printing device includes a frame having four sides forming a void therein for positioning the printing device.

According to yet another preferred embodiment of the present invention, the printing device of the present invention wherein the printing mechanism is a laser printing mechanism.

### BRIEF DESCRIPTION OF THE DRAWINGS

The present invention is illustrated and described herein with reference to the various drawings, in which like reference numbers denote like method steps and/or system components, respectively, and in which:

FIG. 1 is a perspective view of the printing device;

FIG. 2 is a top view of the printing device;

FIG. 3 is a side view of the printing device;

FIG. 4 is a top view of the printing device;

FIG. 5 is a perspective view of the printing device;

FIG. 6 is a perspective view of one embodiment of the printing mechanism;

FIG. 7 is a perspective view of one embodiment of the printing mechanism and cylindrical object;

FIG. 8 is a top view of one embodiment of the retention device;

FIG. 9 is a top view of one embodiment of the printing mechanism; and

FIG. 10 is a block diagram of a computer system.

### DETAILED DESCRIPTION OF THE INVENTION

Referring now specifically to the drawings, an exemplary printing device is illustrated in FIG. I and is shown generally at reference numeral 10. As illustrated, the device 10 has four sides 12, a top portion 14, and a bottom portion 16 that collectively form the housing 18 of the printing device 10. However, any suitable number of sides 12 can be used. The sides 12 are in a spaced apart relationship forming an interior void within. A printing mechanism 20 is housed within the device 10 for printing an image, logo or the like on a cylindrical or spherical object. The printing mechanism 20 has the ability to print in both black and white images and color. A rolling mechanism 22 is also located within the housing 18. The object to be printed upon is positioned on the rolling mechanism 22 and rotated while the printing mechanism 20 deposits ink on the surface of the object.

The housing may include a top portion 14, a bottom portion 16, and sides 12, including at least one side portion 24 and a front portion 28. The front portion 28 may be a partial front portion 28 allowing for easy placement of the object to be printed on the rolling mechanism 22. Additionally, the front portion 28 may be removable or pivotable, thus allowing the front portion 28 to be removed or pivoted so that an object to be printed may be placed on the rolling mechanism 22. The housing 18 may be composed of any material suitable to the user, including, but not limited to, metal, fiberglass, wood, and plastic.

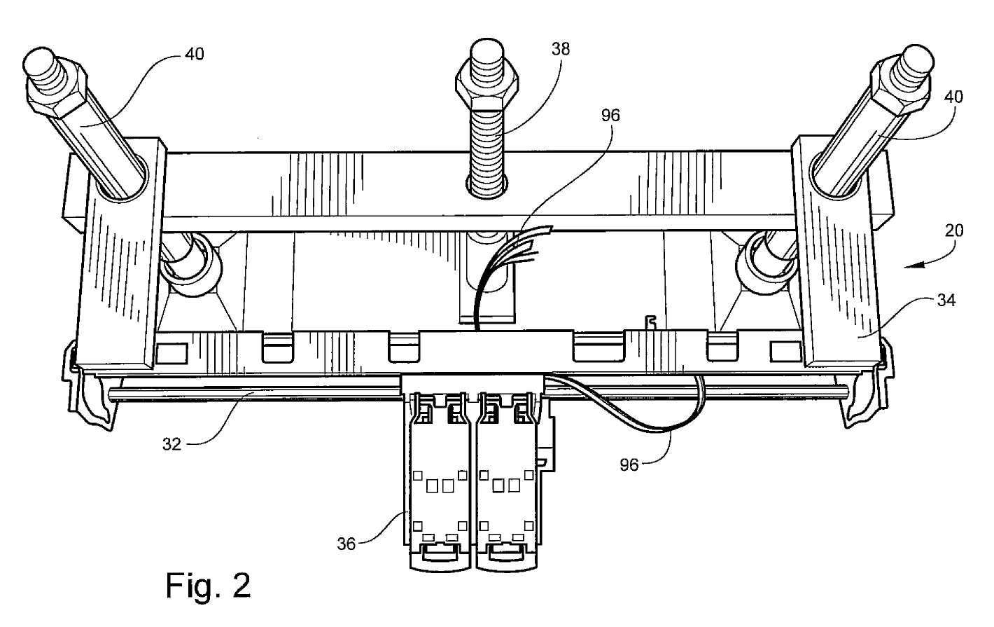

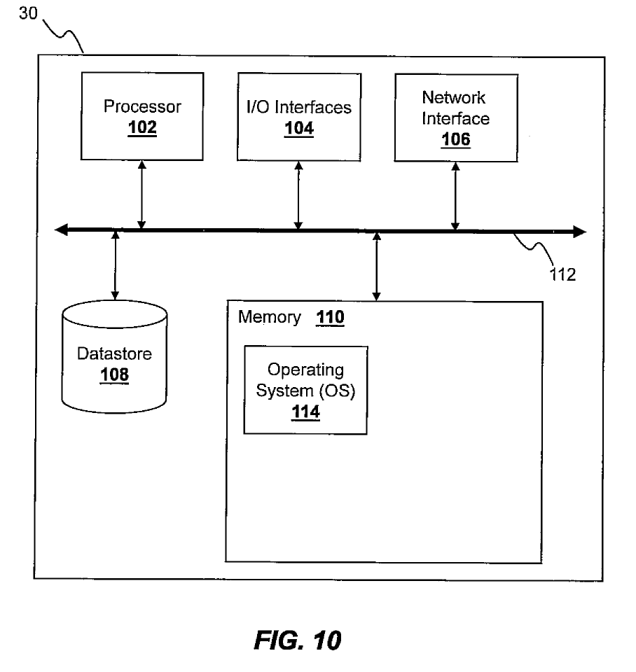

The printing mechanism 20, as illustrated in FIG. 2, may be any sort of printing system such as a thermal wax, inkjet, dye sublimations, and laser, but an inkjet printing system is preferred. The printing mechanism 20 may be adjustable to print on a number of different sizes of cylindrical or spherical objects, having varying heights and widths. The printing mechanism 20, along with other components of the device 10, is connected to a computer system 30 for controlling the printing mechanism 16. The computer system 30 instructs the printing mechanism 20 as to the image, logo or the like to print on the cylindrical or spherical object. The computer system 30 (as shown in FIG. 10) contains software that has the ability to upload images and communicate with the printing mechanism 20 for printing the image onto the cylindrical or spherical object. In addition thereto, the computer system 30 may contain scanning capabilities, thus allowing an image to be scanned and stored in the memory of the computer system 30 prior to printing the image on the cylindrical or spherical object. In another exemplary embodiment, the computer system 30 utilizes imaging processing software to receive and manipulate an image. The imaging processing software may include such software programs as Adobe® Photoshop® or the like.

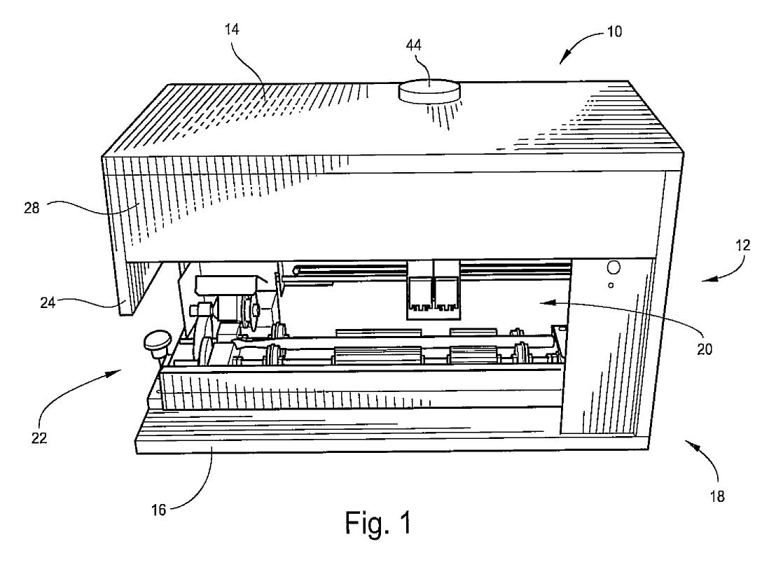

The printing mechanism 20 includes a track 32, a frame 34 for engaging the track 32, and a printing head 36, wherein the printing head 36 is engaged to the track 32, as illustrated in FIGS. 2, 3, and 4. The term printing head 36 as used herein shall be defined as having at least one printing head. The frame 34 is slidingly engaged to three uprights, including an adjustment upright 38 and two stabilization uprights 40. The frame 34 includes a threaded bore 42 for receiving a correspondingly threaded adjustment upright 38. The adjustment upright 38 includes a knob 44 for adjusting the height of the frame with respect to the adjustment upright 38 and stabilization uprights 40, as shown in FIG. 1. In the exemplary embodiment, as the knob 44 (as shown in FIG. 1) is rotated, the adjustment upright 38 rotates, thus causing the threaded bore 42 to translate along the adjustment upright 38, thus moving the frame 34 in the vertical direction. The stabilization uprights 40 are in a slidingly engaged arrangement with the frame 34 and are meant to provide support and stabilize the frame 34 during the printing process and translation in the vertical direction. In another exemplary embodiment, the adjustment upright 38 provides enough stability and support to negate the use of the stabilization uprights 40.

During the printing process, the printing head 36 moves within the track 32 while applying ink to the object. In other words, the track 32 suspends the printing head 36 above the object that is being printed. In the exemplary embodiment as illustrated in FIGS. 2, 3, and 4, the track 32 is a horizontal bar spaced apart from the frame that engages the printing bead 36, thus allowing the printing head 36 to slide horizontally along the bar while depositing ink on the surface of the object.

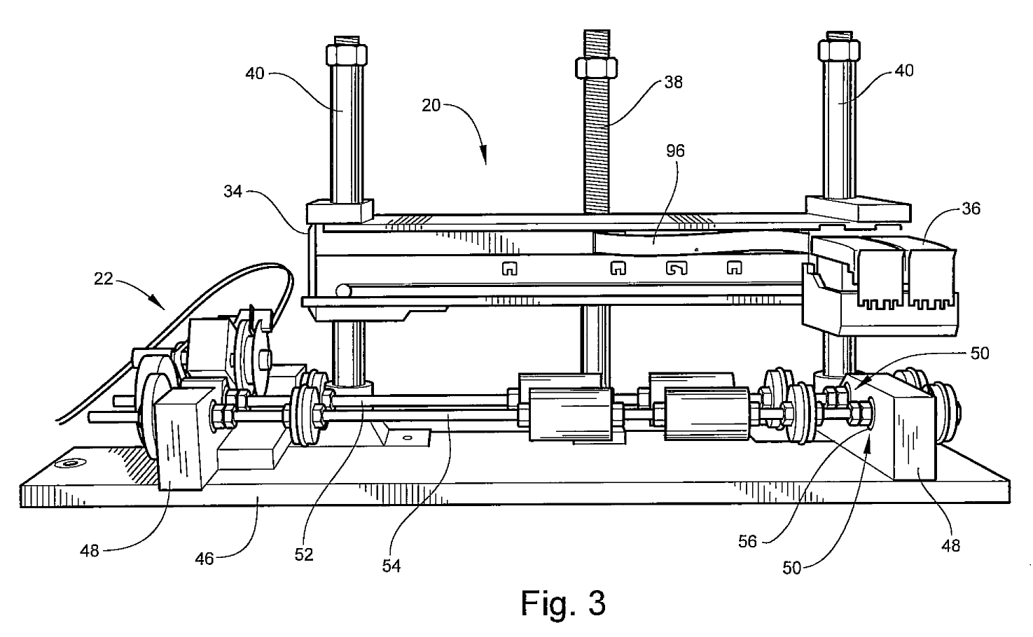

The rolling mechanism 1S, as illustrated in FIGS. 3, 4, and 5, includes a base 46 with two supports 48 extending therefrom. The supports 48 contain two bores 50 for receiving a first shaft 52 and a second shaft 54. The bores 50 include a bearing 56 therein for aiding in the rotation of the first shaft 52 and second shaft 54.

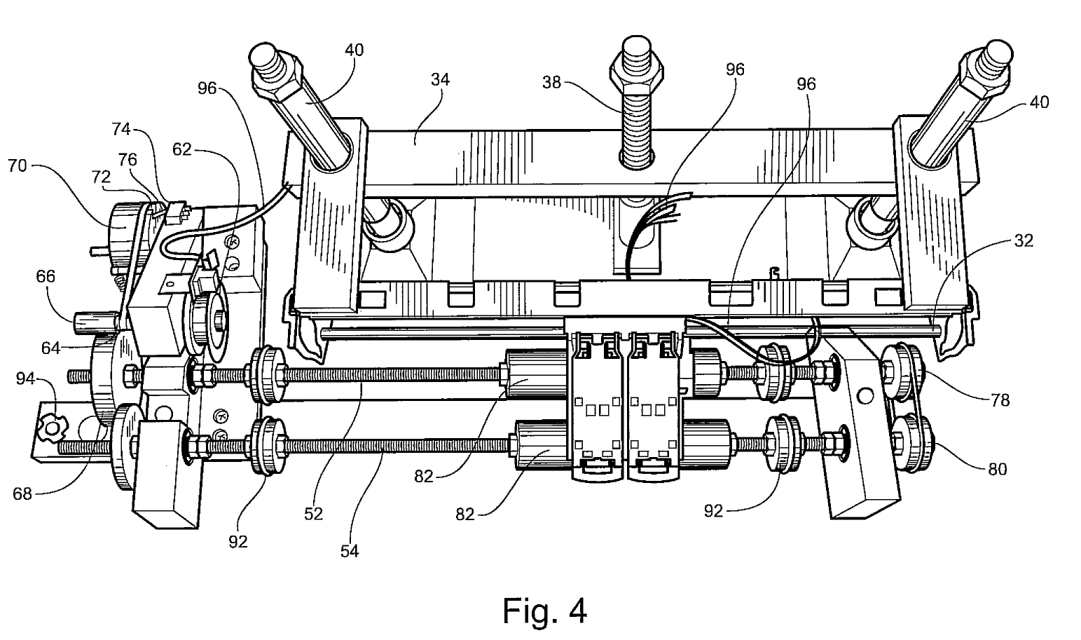

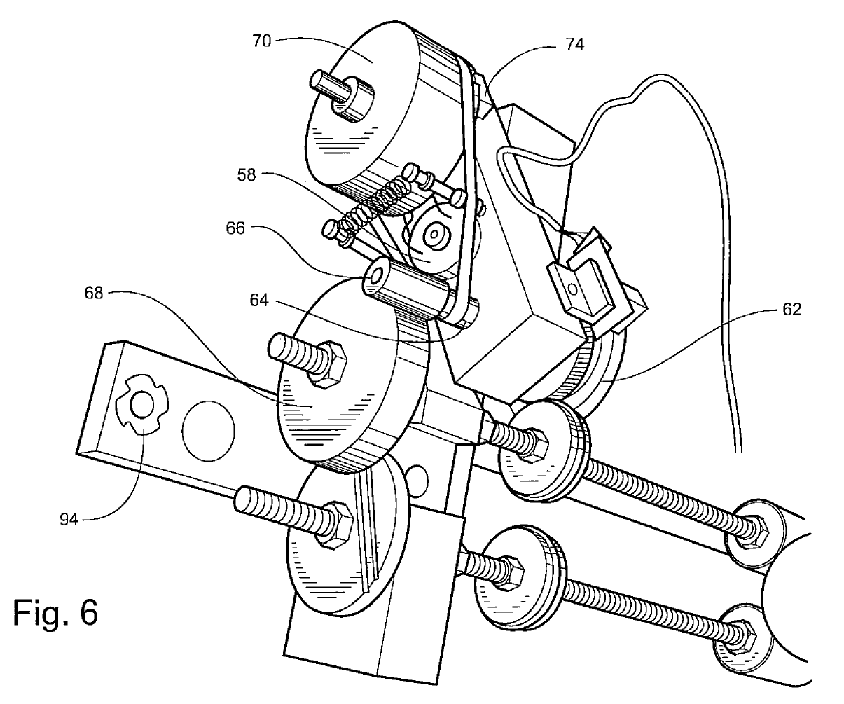

The device 10 includes a drive mechanism 58, as illustrated in FIG. 6. The drive mechanism 58 may be any electrical motor known to one of skill in the art to provide adequate power to the device 10. Optionally, the device 10 may be hand driven with a hand crank (not shown), depending upon the application of the user. The drive mechanism 58 includes a drive mechanism gear 60 that drives a master gear 62, as shown in FIG. 6. The master gear 62 rotates a master gear shaft 64 attached thereto. A gear 66 positioned on the master gear shaft 64 engages a first shaft gear 68 that rotates the first shaft 52. Additionally, a timing gear 70 is engaged to the master gear shaft 64 that serves as a timing device. In other words, the timing gear 70 may have the same diameter as the object to be printed. The timing gear 70 may have an indication point 72 that provides an indication of when the timing gear 70 has completed a full rotation. The indication point 72 may be a cleft or slot as illustrated in FIGS. 4, 5, and 6 or may be a sensor assembly. As illustrated in FIGS. 4, 5, and 6, a sensor 74 is positioned adjacent the timing gear 70. As illustrated, the sensor 74 is a mechanical sensor that is in communication with the computer system 30.

Prior to operation, the spring arm 76 of the sensor 74 is positioned within the indication point 72. As the timing gear 70 begins to rotate, the spring arm 76 is disengaged from the indication point 72. After the timing gear 70 has completed a complete rotation, the spring arm 76 is again positioned with the indication point 72, thus indicating to the sensor 74 that a complete rotation has occurred. The indication that the timing gear 70 has made a complete revelation. The computer system 30 is in communication with the sensor 74, and once the sensor 74 communicates to the computer system 30 that a complete rotation has occurred, the computer system 30 ceases further printing by communicating with the printing mechanism. Alternatively, the indication point 72 can be utilized to notify the sensor 74 that a rotation of any size has occurred, instead of a complete rotation of the timing gear 70. In another alternative embodiment, more than one indication point 72 and sensor 74 may be utilized to determine the extent of rotation of the timing gear 70.

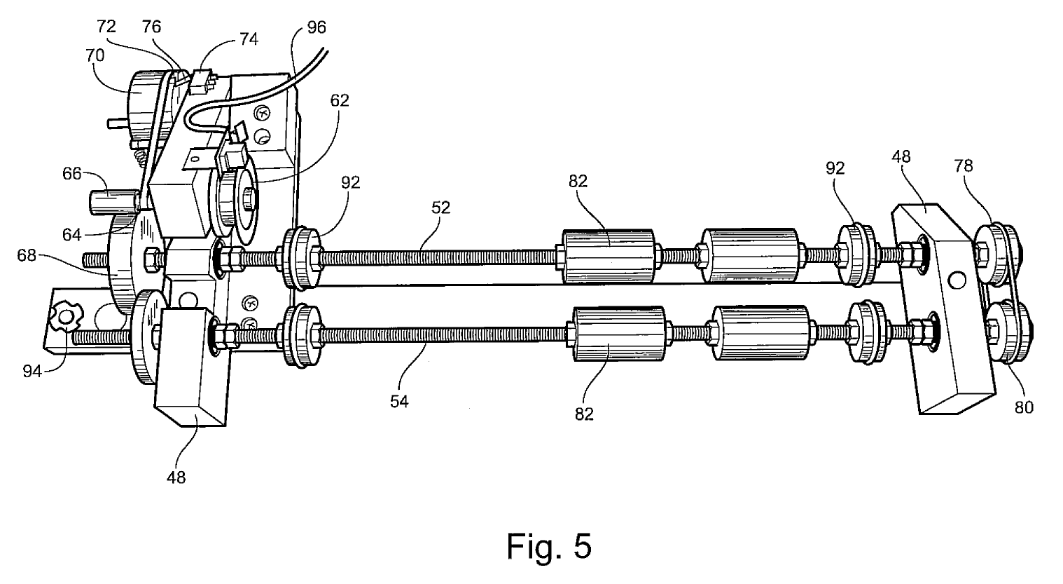

The first shaft 52 further includes an end gear 78 positioned in close proximity to the end of the first shaft 52. The first shaft end gear 78 engages a second shaft end gear 80 also positioned in close proximity to the end of the second shaft 54. As the first shaft 52 rotates, the first shaft end gear 78 also rotates, thus causing the second shaft end gear 80 to rotate that in turn rotates the second shaft 54. In other words, through the use of the first shaft end gear 78 and second shaft end gear 80, the rotation of the first shaft 52 results in the rotation of the second shaft 54. As illustrated in FIGS. 4 and 5, the first shaft gear 78 and second shaft gear 80 form a belt train. However, in another embodiment of the invention, the first shaft gear 78 and second shaft gear 80 form a gear train.

At least one barrel 82 is positioned on the first shaft 52, wherein the first shaft 52 serves as the axis of rotation of the barrel 82. As the first shaft 52 is rotated, the barrel 52 rotates in unison therewith. At least one barrel 82 is also positioned on the second shaft 54, wherein as the second shaft 54 serves as the axis of rotation of the barrel 82 located thereon. The barrel 82 positioned on the second shaft 54 is positioned within close proximity to the first shaft 52 and barrel 82 positioned on the first shaft 52.

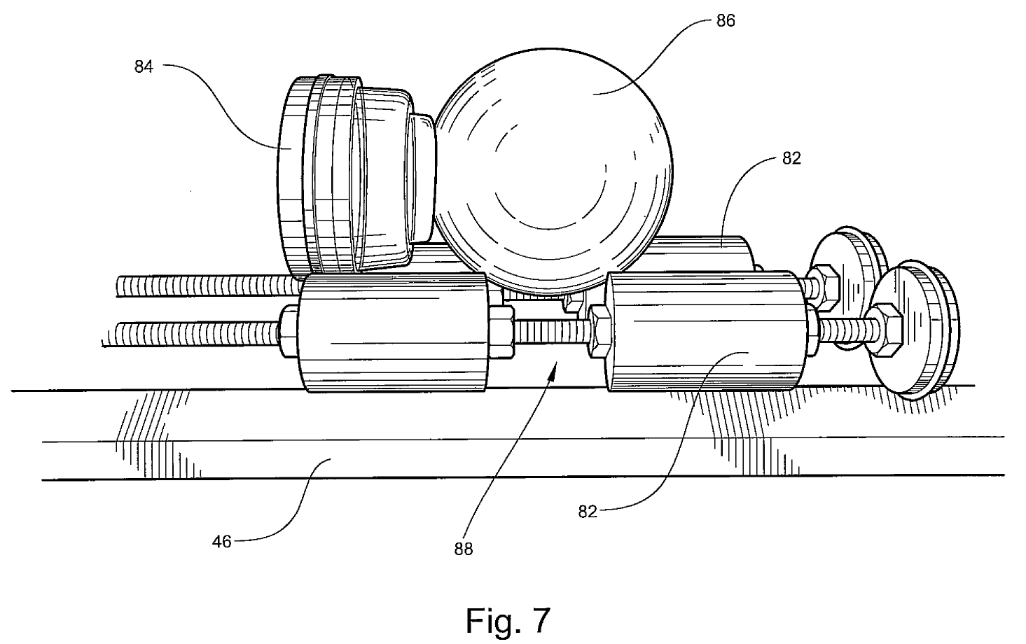

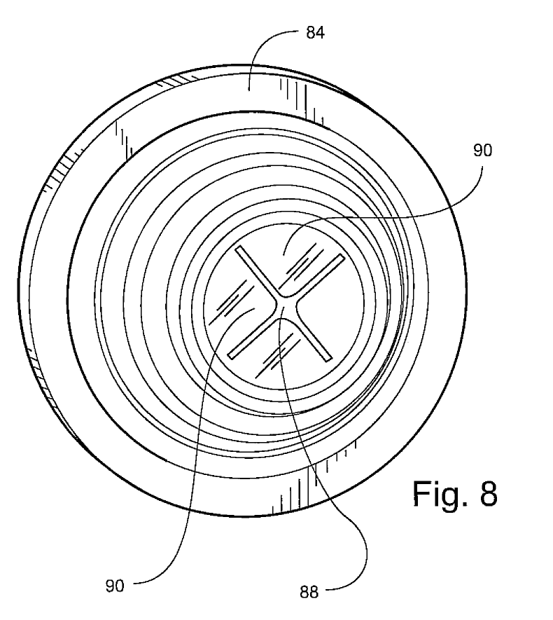

A retention device 84, as shown in FIG. 7, may be positioned on the first shaft 52 and second shaft 54. The retention device 84 retains the object that is to be printed. In the illustrated example, the retention device 84 retains an object similar to a spherical Christmas ornament 86. The head of the ornament 86 is received within a cavity 88 of the retention device 84. Resilient, flexible finger members 90 at the entrance to the cavity 88 retain the head of the ornament 86 within the cavity 88, as shown in FIG. 8. The retention device 84 is positioned such that it rotates in unison with the first shaft 52 and second shaft 54. As the retention device 84 rotates, the object retained within the retention device 84 also rotates. The diameter of the retention device 84 may be of varying dimensions to dictate the velocity of the object to coincide with the printing mechanism 16. The purpose of the retention device 84 is to position and support the ornament 86 during printing. As shown in the illustrated example, the retention device 84 positions the ornament 86 such that the axis of rotation is parallel to the axis of rotation

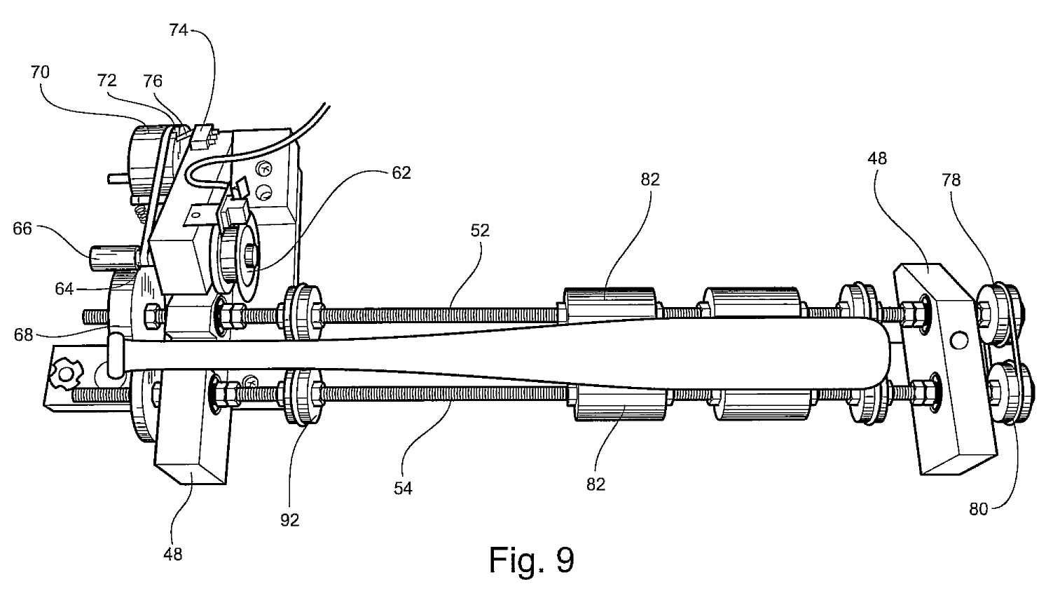

In another exemplary embodiment as shown in FIG. 9, the support members 92 may be included on the first shaft 52 and second shaft 54. These support members 92 can serve a number of purposes. For instance, these support members 92 may be utilized to aid in the retention of a cylindrical or spherical object that is positioned on the barrels 82 for printing. In other words, these support members 92 act as a retention device for preventing the object from moving in the lateral direction during the printing process. In addition, the support members 92 may also aid in the stabilization of the retention device 84 during operation, thus acting as a brace for preventing the retention device 36 from moving laterally during operation. In the illustrated example of FIG. 9, the support members 92 are utilized to retain a baseball bat.

The printing device 10 may be adapted to print any cylindrical or spherical object through the use of the support members 92. It is understood that the present invention applied to any substantially circular object. For instance, baseballs, baseball bats, footballs, basketballs, golf balls, drinking glass, plastic cups, Christmas ornaments and the like may be printed with the use of the present invention. The barrels 82 as illustrated in FIG. 7 are in a spaced apart relationship on the first shaft 52 and second shaft 54, allowing the larger diameter portion of the Christmas ornament 86 to be positioned within the space between the barrels 82. In other words, the area of the Christmas ornament 86 with the largest diameter is received within the space located between the barrels 82. The edges of the barrels 82 engage the ornament 86, while the larger diameter portion of the ornament 86 is located within the space located between the barrels 82. Ideally, the surface to be printed does not touch any other surface, thus allowing the ink of the image printed to dry. It is further understood that the term circular as used herein is mean to include shaped objects that are perfectly round, partially round, spherical, oval, cylindrical or other irregularly shaped objects.

Additionally, an adjustment device 94 is located on the base 46 for adjusting the base 46 with respect to the printing mechanism 16, as illustrated in FIGS. 4, 5, and 6. The adjustment device 94 may adjust the base 46 in the horizontal and/or vertical direction, depending upon the desires of the user. The adjustment device 94 allows the cylindrical object to be printed to be adjusted relative to the printing mechanism 16 for improving the contact between the object and the printing mechanism 16.

Referring to FIG. 10 that illustrates an exemplary embodiment of the present invention, a block diagram illustrates a computer system 30. The computer system 30 can be a digital computer that, in terms of hardware architecture, generally includes a processor 102, input/output (I/O) interfaces 104, network interfaces 106, memory 108, and a data store 110. The components (102, 104, 106, 108, and 110) are communicatively coupled via a local interface 112. The local interface 112 can be, for example but not limited to, one or more buses or other wired or wireless connections, as is known in the art. The local interface 112 can have additional elements, which are omitted for simplicity, such as controllers, buffers (caches), drivers, repeaters, and receivers, among many others, to enable communications. Further, the local interface 112 can include address, control, and/or data connections to enable appropriate communications among the aforementioned components.

The processor 102 is a hardware device for executing software instructions. The processor 102 can be any custom made or commercially available processor, a central processing unit (CPU), an auxiliary processor among several processors associated with the computer system 30, a semiconductor-based microprocessor (in the form of a microchip or chip set), or generally any device for executing software instructions. When the computer system 30 is in operation, the processor 102 is configured to execute software stored within the memory 108, to communicate data to and from the memory 108, and to generally control operations of the computer system 30 pursuant to the software instructions.

The I/O interfaces 104 can be used to receive user input from and/or for providing system output to one or more devices or components. User input can be provided via, for example, a keyboard and/or a mouse. System output can be provided via a display device and a printer (not shown). I/O interfaces 104 can include, for example, a serial port, a parallel port, a small computer system interface (SCSI), an infrared (IR) interface, a radio frequency (RF) interface, and/or a universal serial bus (USB) interface.

The network interfaces 106 can be used to enable the computer system 30 to communicate on a network. A data store 110 can be used to store data. The data store 110 can include any of volatile memory elements (e.g., random access memory (RAM, such as DRAM, SRAM, SDRAM, and the like)), nonvolatile memory elements (e g., ROM, hard drive, tape, CDROM, and the like), and combinations thereof. Moreover, the data store 108 can incorporate electronic, magnetic, optical, and/or other types of storage media. In one example, the data store 108 can be located internal to the computer system 30 such as, for example, an internal hard drive connected to the local interface 220 in the computer system 30. Additionally in another embodiment, the data store can be located external to the computer system 30 such as, for example, an external hard drive connected to the I/O interfaces 204 (e.g., SCSI or USB connection). Finally in a third embodiment, the data store may be connected to the computer system 30 through a network, such as, for example, a network attached file server.

The memory 108 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof Moreover, the memory 108 may incorporate electronic, magnetic, optical, and/or other types of storage media. Note that the memory 108 can have a distributed architecture, where various components are situated remotely from one another, but can be accessed by the processor 102.

The software in memory 108 can include one or more software programs, each of which includes an ordered listing of executable instructions for implementing logical functions. In the present invention, the software in the memory system 108 includes a suitable operating system (O/S) 114. The operating system 114 essentially controls the execution of other computer programs. The operating system 114 can be any of Windows NT, Windows 2000, Windows XP, Windows Vista (all available from Microsoft, Corp. of Redmond, Wash.), Solaris (available from Sun Microsystems, Inc. of Palo Alto, Calif.), or LINUX (or another UNIX variant) (available from Red Hat of Raleigh, N.C.).

The computer system 30 contains software to receive a digital image of a surface of a material that is scanned, using conventional scanners, as a digital image of the irregular surface into memory of the computer system 30. In one embodiment, the computer system 30 uses image processing software such as Adobe® Photoshop® to receive and manipulate the digital image. On the computer system 30 is also stored a digital design of the design that a user wishes to place on the object that will be positioned on the rolling mechanism 22 as of FIGS. XX. It is understood that the design may be any digital image representing any design or picture (e.g. photograph). The computer system 30 is in communication with the printing mechanism 20 through standard data transmission. This data transmission is done using any data transmission medium, including infra-red, cellular, radio-frequency, satellite, Bluetooth® technology or standard cables 96. The communication means is between the computer system 30, the printing mechanism 20, printer drive mechanism (not shown), and sensor 74 where the computer system 30 is able to control all of these components. A numerical pressure gradient is identified for each discrete strip by the computer system 30 to control the printing mechanisms 20 and particularly the printing head 36. Specifically, the pressure gradient is used to control the inkjet nozzle on the printing head 36 to compensate for distance variations between the inkjet nozzle and the print surface of the object. The modified discrete strips are realigned into a digital design that has been modified, hereinafter termed the modified digital design. The modified digital design includes a print surface size, length, width, and nozzle pressure settings. At this point, the modified digital design is stored on the computer system 30 and is ready for printing onto the object. The object is, in one embodiment, prepared by placing one or more formulations or coatings onto the surface of the object prior to being positioned on the printing mechanism 20. These formulations or coatings enable the ink to be placed onto the object by the printing head 36 to adhere properly to the object. It is noted that multiple coatings may be required, in one embodiment, in order for the proper adhesion of the ink. In an alternative embodiment, a solvent-based ink may be used that already has adhesive properties so that a separate pre-coating step of an adhesive material is not necessary. The solvent-based ink may be used in conjunction with a solvent-based ink printer. The modified design is then selected by the computer system 30. The height of the printing mechanism 20 may be adjusted using the knob 44. This knob may be utilized, thus raising or lowering the frame 34, in order to print onto a material that is thicker or wider than the current placement of the knob. A printing head 36 is used to move across the surface of the object to place the modified digital design received from the computer system 30 onto the material. Thus, the printing head 36 moves in four directions; laterally from side to side along the object and also back and forth along the rolling mechanism 22. In this manner, the printing head 36 is able to place the modified digital design onto the object. The object is physically aligned in strict agreement to the printing coordinates of the modified digital design, as well as the digital design. Also as part of the rolling mechanism are a retention device 84, preferably used when the object is a Christmas ornament, or support members 92 that may be used for other objects. The printing head 36 also contains print head nozzles (not shown) that place the ink onto the object and are controlled by the computer system 30. In one embodiment, the printing head 36 is a standard ink jet printer that is commercially available and that is integrated into the device 10.

In use, in order to activate the print activation, certain computer instructions are transmitted through communication means to the printing mechanism 20 from the computer system 30. Specifically, the instructions are sent to the printing mechanism 20 that may include a drive assembly by way of a communication means. The drive assembly of the printing mechanism 20 will propel the printing head 36, that contains the printer nozzles that place the ink onto the object. It is noted that any standard inkjet printing device may be contained within the printing mechanism 20, such as a Hewlett-Packard® inkjet system, as is known in the art. The printing head 36 traverses the entire length of the object and places the digital image or modified digital image onto the object.

In operation, the circular or spherical object is first obtained. In the case of a Christmas ornament, any typical glass Christmas ornament or other material may be used as a starting point for printing an image on the Christmas ornament. In the case of other substantially cylindrical or spherical objects, such as a baseball, golf ball, glass and the like, those objects may be in their standard state after purchase. To print the image on these substantially circular objects, the image is transferred to the computer system 30 using well known techniques for transferring data to a computer system 30. The image may be in any one of a number of well known data types, such as TIF or JPEG or other image files. In one embodiment, the image is a photograph of a human being, such as the face of a child to be placed on the Christmas ornament. The computer system 30 is in communication with the printing mechanism 20 using standard communication means as described above. In addition, the computer system uses any of a variety of image processing software, including, in one embodiment, Adobe® Photoshop®. It is well understood that a number of image processing software is available on the market and may be used in alternative embodiments. The computer system 30 is able to transfer the image from the computer to the printing mechanism 20 to deposit the ink onto the Christmas ornament.

The object is first placed on the rolling mechanism 22, and preferably placed on the rolling mechanism 22 between the first shaft 52 and second shaft 54. As illustrated in FIGS. 7 and 9, the type of object being printed determines the exact location the object is placed. For example, as illustrated in FIG. 7, a Christmas ornament is positioned between the shafts, and more particularly, the ornament is positioned between the barrels 82 positioned on the shafts. The Christmas ornament is positioned on the barrels 82 so that the surface to be printed is located between the barrels, but suspended above the first shaft 52 and second shaft 54 without contacting the shaft. A retention device 84 as set forth above, positions and stabilizes the Christmas ornament during the printing process. Alternatively, an object such as a bat is positioned on the support members 92 that suspends the portion of the bat to be printed above the first shaft 52 and second shaft 54. This embodiment is illustrated in FIG. 9. Once the object is placed on the rolling mechanism 22 the object is able to be printed on by the printing mechanism 20, and specifically the printer head 36 positioned above the object. It is understood that, in alternative embodiments, the printing mechanism 20 and/or printing head 36 may also be oriented in the lateral position (rather than on top of the object) to be long the side of the object and thereby print on the object. The object may be similarly oriented to allow printing on the side of the object. It is also noted that, prior to placing a Christmas ornament on the printing mechanism 20, the Christmas ornament is pre-coated with an adhesive material in order to allow the ink placed on the Christmas ornament to adhere to the Christmas ornament. The adhesive material may be any type of glue or other adhesive well known in the art. In one embodiment, the adhesive material may be adhesives manufactured by William Zinsser and Company Inc. (Product No. 02651) of Somerset, N.J. In alternative embodiments, there may be no need for a pre-coating using an adhesive material when an ink containing adhesive properties is used, for example, a solvent-based ink as described above. After pre-coating the Christmas ornament with the adhesive material and after allowing sufficient time for the adhesive material to substantially dry, for example, a few hours of time in one embodiment, Christmas ornament is placed on the rolling mechanism 22. The computer system 30 begins to control the printing mechanism 20 and the drive mechanism 58 in order to print the image onto the object. The computer system 30 controls the printing mechanism 20, and in particular the printing head 36, by controlling the ink flow through the printing head 36 as is well known with other computer printers and the like. The computer system 30 also controls the movement of the printing head 36 along the track 32 during the printing process. Additionally, the computer system 30 also communicates with the drive mechanism 58 in order to spin the first shaft 52 for rotating the object along the x-axis or axis of rotation and thereby deposition ink from the printing head 36 onto the object as the locations as determined by the computer software (for example Adobe® Photoshop®) in order to replicate the image from the computer system 30 onto the object. In another embodiment, the image is placed onto the object and allowed to dry (for example for a number of hours), the object is then coated with a protective material, for example the lacquers and polyurethane finishes manufactured by Deft, Inc. of Irvine, Calif. It is further noted that additional embodiments can have more than one coating of either the protective material and/or the adhesive material in order to better protect and/or adhere to the object. In a still further embodiment since the object may be made of clear glass, or, alternatively, may be a color not desired by the intended recipient, a pre-coat of color ink on the object may be performed. This pre-coat of color ink may, in this embodiment, follow the steps of placing the object on the rolling mechanism 22 and placing a certain color ink on the object after an adhesive material has been placed on the object. In an another alternative embodiment, the ink itself may have adhesive or protective material already contained within the ink and therefore the adhesive material and protective material steps are not needed. In yet another embodiment of the present invention, the adhesive material or the protective material may have color ink already as part of the material, so additional ink may not be needed. Again, the color ink is placed over the adhesive material after the adhesive material has been allowed a sufficient time to substantially dry. Then before the image is placed onto the color ink, a second adhesive coating is placed over the color ink and allowed to dry before the image is placed on the object in this embodiment.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A printing device for printing the surface of a cylindrical or spherical object, comprising:
a drive mechanism;
a printing mechanism; and
a rolling mechanism, wherein the rolling mechanism comprises:
a first shaft and a second shaft positioned in a spaced-apart relationship for receiving the object to be printed, wherein the drive mechanism rotates at least the first shaft, causing the object to rotate.

2. A printing device according to claim 1, further comprising a drive mechanism gear.

3. The printing device according to claim 1, further comprising a master gear.

4. The printing device according to claim 1, further comprising a master gear shaft.

5. The printing device according to claim 4, further comprising a gear positioned on the distal end of the second shaft which is connected to the transfer gear by way of a belt for rotating the second shaft.

6. The printing device according to claim 1, further comprising a sensor having a spring arm.

7. The printing device according to claim 1, wherein the housing includes four sides.

8. A printing device for printing the surface of a cylindrical or spherical object, comprising;
a computer system;
a printing mechanism; and
a rolling mechanism, wherein the rolling mechanism comprises:
a first shaft and a second shaft positioned in a spaced-apart relationship having at least one barrel positioned on the first shaft and at least one barrel positioned on the second shaft, wherein a drive mechanism rotates at least the first shaft causing the object to rotate.

9. The printing device of claim 8, further comprising a computer system for controlling the printing device.

10. The printing device of claim 8, wherein the printing mechanism comprises a track and a printing head.

11. The printing device of claim 8, wherein the printing mechanism is an ink jet printing mechanism.

12. The printing device of claim 8, further comprising a sensor for determining the rotation of the cylindrical device.

13. The printing device of claim 8, further comprising a sensor having a spring arm.

14. A method for printing an image upon a cylindrical or spherical object, comprising:
providing a drive mechanism, a printing mechanism, and a first shaft and a second shaft positioned in a spaced-apart relationship having at least one barrel positioned on the first shaft and at least one barrel positioned on the second shaft;
providing an object to be printed;
placing the object between the barrels positioned on a first shaft and a second shaft;
initialing the drive mechanism for rotating at least the first shaft; and
operating the printing mechanism for printing an image upon the cylindrical object as the object is rotated by the drive mechanism.

15. The printing device according to claim 14, wherein the image is a digital image of a face of a human being.

16. The printing device according to claim 14, wherein the object is a substantially circular Christmas ornament.

17. The printing device according to claim 14, further comprising pre-coating the object with an adhesive material; and
allowing the adhesive material to dry.

18. The printing device according to claim 16, further comprising providing a retention device for positioning the Christmas ornament below the printing mechanism.

19. The printing device according to claim 14, further comprising providing the image from a computer system to the printing mechanism.

20. The printing device according to claim 14, further comprising rotating the object using support members.
